(19) United States
(12) Patent Application Publication
(10) Pub. No.: US 2024/0233343 A1
(43) Pub. Date: Jul. 11, 2024

(54) Vector Map Verification

(71) Applicant: Google LLC, Mountain Veiw, CA (US)

(72) Inventors: Yan Mayster, Aurora, CO (US); Brian Daniel Shucker, Superior, CO (US)

(21) Appl. No.: 17/928,379

(22) PCT Filed: Sep. 17, 2021
(86) PCT No.: PCT/US2021/050978

§ 371 Date: Nov. 29, 2022

(51) Int. Cl. G06V 10/776; G06T 7/00; G06V 10/40; G06V 10/764; G06V 10/77; G06V 20/10

(52) U.S. Cl. CPC G06V 10/776; G06T 7/0002; G06V 10/40; G06V 10/764; G06V 10/7715; G06V 20/176; G06T 2200/24; G06T 2207/20081; G06T 2207/20084; G06T 2207/30168

(57) ABSTRACT

Methods, systems, devices, and tangible non-transitory computer readable media for vector map verification are provided. The disclosed technology can include accessing image data including information associated with images of a region. The images can be associated with detections of features associated with the images. Validation images can be selected from the images. The validation images can include the images that satisfy image quality criteria. For classes associated with the features and based on comparisons of the images to the validation images, confirmation scores can be determined for the images. The confirmation scores can be associated with an extent to which the detections of the images are similar to detections of the validation images. A user interface comprising indications can then be generated based on the confirmation scores. The indications can be associated with an accuracy of the detections of the features in the images.

### FIELD

The present disclosure relates generally to verification of vector maps and in particular to a system for verification of vector maps in relation to features of an image.

### BACKGROUND

Operations associated with the extraction of features to generate a representation of an image can be implemented on a variety of computing devices. These operations can include processing images in order to generate outputs including a different representation of the original images. For example, machine-learning models can be used to perform segmentation operations so that features in images can be detected and a different representation of those features can be generated for use by a user or other computing system. However, the process of detecting features may be subject to error and the extent to which the different representation of the original image is in accordance with the original images may need to be verified. Accordingly, there is a demand for more effective ways of verifying representations of images that are the result of image detection processes.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method of vector map verification. The computer-implemented method can include accessing, by a computing system comprising one or more processors, image data comprising information associated with one or more images of a region. The one or more images can be associated with one or more detections of one or more features of the one or more images. The computer-implemented method can include selecting, by the computing system, one or more validation images from the one or more images. The one or more validation images can satisfy one or more image quality criteria. The computer-implemented method can include determining, by the computing system, for one or more classes associated with the one or more features and based at least in part on one or more comparisons of the one or more images to the one or more validation images, one or more confirmation scores for the one or more images. The one or more confirmation scores can be associated with an extent to which the one or more detections associated with the one or more images are similar to the one or more detections associated with the one or more validation images from the one or more images. Furthermore, the computer-implemented method can include generating, by the computing system, a user interface comprising one or more indications associated with an accuracy of the one or more detections of the one or more features in the one or more images. The one or more indications can be based at least in part on the one or more confirmation scores for the one or more images.

Another example aspect of the present disclosure is directed to one or more tangible non-transitory computer-readable media storing computer-readable instructions that when executed by one or more processors cause the one or more processors to perform operations. The operations can include accessing image data comprising information associated with one or more images of a region. The one or more images can be associated with one or more detections of one or more features of the one or more images. The operations can include selecting one or more validation images from the one or more images. The one or more validation images can satisfy one or more image quality criteria. The operations can include determining for one or more classes associated with the one or more features and based at least in part on one or more comparisons of the one or more images to the one or more validation images, one or more confirmation scores for the one or more images. The one or more confirmation scores can be associated with an extent to which the one or more detections associated with the one or more images are similar to the one or more detections associated with the one or more validation images from the one or more images. Furthermore, the operations can include generating a user interface comprising one or more indications associated with an accuracy of the one or more detections of the one or more features in the one or more images. The one or more indications can be based at least in part on the one or more confirmation scores for the one or more images.

Another example aspect of the present disclosure is directed to a computing system that can include: one or more processors: and one or more tangible non-transitory computer-readable media storing instructions that when executed by the one or more processors cause the one or more processors to perform operations. The operations can include accessing image data comprising information associated with one or more images of a region. The one or more images can be associated with one or more detections of one or more features of the one or more images. The operations can include selecting one or more validation images from the one or more images. The one or more validation images can satisfy one or more image quality criteria. The operations can include determining for one or more classes associated with the one or more features and based at least in part on one or more comparisons of the one or more images to the one or more validation images, one or more confirmation scores for the one or more images. The one or more confirmation scores can be associated with an extent to which the one or more detections associated with the one or more images are similar to the one or more detections associated with the one or more validation images from the one or more images. Furthermore, the operations can include generating a user interface comprising one or more indications associated with an accuracy of the one or more detections of the one or more features in the one or more images. The one or more indications can be based at least in part on the one or more confirmation scores for the one or more images.

Other example aspects of the present disclosure are directed to other methods, systems, devices, apparatuses, or tangible non-transitory computer-readable media for vector map verification.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1A depicts a block diagram of an example computing system that performs operations associated with vector map verification according to example embodiments of the present disclosure.

FIG. 1B depicts a block diagram of an example of a computing device that performs operations associated with vector map verification according to example embodiments of the present disclosure.

FIG. 1C depicts a block diagram of an example computing device that performs operations associated with vector map verification according to example embodiments of the present disclosure.

FIG. 2 depicts a block diagram of an example of one or more machine-learned models according to example embodiments of the present disclosure.

FIG. 3 depicts an example of an example computing device according to example embodiments of the present disclosure.

FIG. 4 depicts an example of vector map verification according to example embodiments of the present disclosure.

FIG. 5 depicts an example of a user interface implemented on a computing device according to example embodiments of the present disclosure.

FIG. 6 depicts a flow diagram of vector map verification according to example embodiments of the present disclosure.

FIG. 7 depicts a flow diagram of vector map verification according to example embodiments of the present disclosure.

FIG. 8 depicts a flow diagram of vector map verification according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to a computing system that can be used for a variety of purposes including the verification of vector maps. In particular, the disclosed technology can perform operations on images that include vector maps and can verify the vector maps by selecting high quality validation images and using those validation images to determine the accuracy of vector based representations in other, potentially more recent images. Additionally, the disclosed technology can select more recently acquired images that may be of lower quality and use these images to validate how up-to-date the features in a higher quality but less recently acquired image are. Further, the disclosed technology can be used to establish an optimal vector map for an image of a geographic region which may be composed of images that were captured at different times and that may be of varying quality.

The disclosed technology can be implemented in a computing system (e.g., a verification computing system) that is configured to access image data that includes information associated with one or more images of a region. For example, the image data can include one or more images and each of the images can include detections of image features that can be represented as vector maps that correspond to objects in the images such as roads and buildings. The computing system can then select validation images from the one or more images. These validation images can include the one or more images that satisfy image quality criteria. For example, the validation images can include images that meet some set of the image quality criteria including a high resolution, being more recently captured, and offering a clear view of geographic region depicted in the images. Then, for some set of feature classes (e.g., one or more classes of one or more features including road features), the computing system can determine confirmation scores that confirm the accuracy and/or validity of the images. For example, the computing system can compare the one or more images to the validation images and determine that the images that are more similar to the validation images are assigned higher confirmation scores and are more accurate. After determining the confirmation scores the computing system can generate indications based on the confirmation scores for the one or more images. For example, the computing system can generate a user interface that provides a numeric confirmation score that is superimposed over vector based representations associated with features depicted in an image of a geographic region.

Accordingly, the disclosed technology can improve the effectiveness with which the validity and/or accuracy of vector maps and/or vector based representations can be confirmed. These improvements can allow for vector maps that more closely conform to the actual features depicted in the associated images.

The determination of whether a vector based representation of an image is accurate can be based on the use of a confirmation score. The confirmation score can be flexible parameterized so that certain aspects of the image are weighted more heavily than others. For example, the quality and age of an image can be used as factors and weighted to achieve an effective balance between the sought after recentness of the image and the accuracy of the feature representation.

First, an image quality metric can be a function based on factors including the recentness of an image (e.g., the image's age), the resolution of the image, the angle and pose quality from which the image was captured, the amount of haze in the image (e.g., the amount of cloud cover). Then, for any given region (e.g., the region can be part of a grid subdivision of the world in which each region is a polygonal cell or defined latitude and latitude section) N validation images that have the highest score according to the image quality metric are selected. In some cases, selection of the validation images can be constrained such that the validation images M of the most recent images (the recentness and number of recent images can be a parameter that is adjusted based on the imagery in a region) are selected from available images.

The computing system can then process the detections of features from the selected images, one class (e.g., one feature class) at a time, starting with the highest scoring detection and continuing one candidate detection at a time, and confirming it against the detections from the full stack of available images (“validation” detections). In some instances detections with model confidence values that are too low to be credible can be discarded immediately. Then, the system can order the “validation” detections chronologically, and for each “candidate”, if “validation” overlaps it by more than P % (e.g., if the validation overlaps by more than P % of its area or has a Hausdorff distance within a maximum tolerance for lines/points), record a 1 for the image from which the “validation” had been inferred, otherwise, if no detection from that image validated the candidate, a 0. This would yield a chronological sequence of 0s and 1s, which is the “confirmation” sequence for a candidate detection. A confirmation score can then be assigned to the candidate feature detection D as the sum of the image quality scores Q(I) for those images I that were recorded as a 1 in the “confirmation” sequence S. If the imagery quality metric does not factor in the age A of an image, we can additionally weight by image age WA(I), so that less recent confirmations contribute less to the total score. The total score can be defined as follows:

$$Score ( detection ) = Sum\_ {( m = 1 )}^{∧} n Sm * WA ( Im ) * Q ( Im ) .$$

In some embodiments, the score could be weighted by the proportion of overlap between the two detections, instead of using Sm={0, 1}.

As the candidate images and their respective detections are cycled through, a greedy algorithm can be used to approve only those detections that don't conflict with already “approved” detections. For example, the criteria for approval can include the use of an intersection over union that exceeds an approval threshold that has a validation score that is above a predetermined calibrated threshold. In some embodiments, the confirmation scores can be normalized within each area and a mean score computed as the representative confirmation score of that area. Using a graphical user interface, a user may be presented with these scores (e.g., the scores can be displayed within the interface when the user hovers a pointer over a feature or a mean confirmation score for the viewed area that is displayed in the map corner) as they pan around the map.

When multiple different machine-learned models are used, there will be multiple sets of detections for each image, with different sets of detections for each machine-learned model that is used. The confirmation sequences of detections can be based on selection of a single set for each image. In some embodiments, the output of the machine-learned model that yields performance that exceeds some performance criteria (e.g., the characteristics of the image (e.g., image resolution), the geographic region, and/or time of year) can be selected. Effectively, a simple function M(I) can be constructed to return the identity of the best model for image I based on the specs of I.

In the case when multiple feature classes are detected by the machine-learned models, there can be a per-pixel class assignment based on a machine-learned model confidence threshold. This may indicate that there is a threshold for any image/model combination based on whether a pixel is identified by that machine-learned model as belonging to a particular feature class and thus confirming or rejecting the candidate detection there.

Further, there can be rules that specify that certain feature classes are mutually exclusive while certain other classes may not be mutually exclusive (e.g., when dealing with roads vs parking, for example, vs buildings and roads, the latter being exclusive while the former are not necessarily so). As such, each term in the summation from the confirmation sequence can receive one more “class-fungibility” multiplicative factor, 1 if the two feature classes are the same, 0 if the two feature classes are mutually exclusive, and something in (0, 1) if the two feature classes are mutually fungible to some extent.

Furthermore, the confirmation score for a region can be determined with respect to the image used for the “satellite” view of the region, which is not necessarily the most recent available image. This can be achieved by determining “validated” detections for the stack of imagery in the region, and the “validated” detections for the images chronologically up to and including the image chosen for the satellite view of the region. Then, the difference (e.g., as the total intersection-over-union measure, between the two sets) can be determined and used as the image's indication of accuracy and/or fidelity via the available vector data.

The computing system can access, receive, obtain, and/or retrieve data including image data. The image data can include information associated with one or more images of a region. For example, the image data can include information associated with a time and/or date at which each of the one or more images was captured. Further, the image data can include information associated with one or more images of a region that were captured (e.g., captured by an image capture device that can include a camera). In some embodiments, the one or more images can include a single image that was captured at a single time interval. In some embodiments, the one or more images can be captured over a plurality of time intervals (e.g., images of a geographic region that were periodically captured on a weekly and/or monthly basis). Further, in some embodiments, the one or more images can be captured from different angles, perspectives, and/or distances. As described herein, any operation and/or action (e.g., accessing, determining, generating, sending, receiving, and/or selecting) performed on one or more images can be performed on a single image and/or a set of the one or more images. Further, any operation and/or action performed on a single image and/or a set of the one or more images can be performed on one or more images.

The one or more images can be associated with one or more detections of one or more features of the one or more images. For example, the one or more detections of one or more features of the one or more images can be used to generate one or more vector maps that can include one or more vector based representations that indicate and/or show features associated with a class of a feature (e.g., a vector based representation that is superimposed over roads in a region).

In some embodiments, each of the one or more images includes a plurality of points (e.g., a plurality of pixels). For example, the input image can include an overhead image of a geographic area that is captured by a satellite that passed over the geographic region.

In some embodiments, the one or more features can include one or more features associated with one or more objects in the region. Further, the one or more detections of the one or more features can be performed by one or more machine-learned models that have been configured and/or trained to detect and/or recognize certain visual aspects of the one or more images. The one or more features of the region can include one or more colors, one or more shapes, and/or one or more textures that can be associated with a class of a feature (e.g., a feature class). For example, a combination of straight lines, contrasting colors, and markings can be associated with a class of a feature including, for example, roads and/or streets.

Each of the one or more images can include information associated with a set of values that represent an image captured by some sensor (e.g., an image capture device). Further, each of the one or more images can include a plurality of points (e.g., pixels) and each point can include information associated with visual information of the image (e.g., the color of each pixel which can be expressed as a set of YUV values).

The computing system can select one or more validation images from the one or more images. The one or more validation images can include the one or more images that satisfy one or more image quality criteria. For example, the computing system can select one or more validation images that are of high quality based at least in part on one or more image quality criteria including image resolution, an amount of haze in an image, and/or an amount of occlusion in an image. For example, the one or more validation images can include an image that has a higher resolution than other images in the one or more images and that does not have any visible haze (e.g., exhaust from factories) and/or occlusions (e.g., image artifacts that obscure one or more features of an image).

The computing system can determine, for one or more classes (e.g., one or more feature classes) associated with the one or more features and/or based at least in part on one or more comparisons of the one or more images to the one or more validation images, one or more confirmation scores for the one or more images. The one or more comparisons can include one or more comparisons of individual images of the one or more images to the one or more validation images. Further, the one or more confirmation scores can be associated with an extent to which the one or more detections of the one or more images are similar to the one or more detections associated with the one or more validation images. For example, the computing system can perform one or more comparisons of a class of a feature (e.g., road features) of the one or more images to the same class of a feature (e.g., road features) of the one or more validation images. In some embodiments, the one or more confirmation scores can be associated with an extent to which the one or more detections of each image of the one or more images is similar to the one or more detections associated with the one or more validation images.

Based at least in part on the one or more comparisons, the computing system can determine an amount of similarity between the one or more images and the one or more validation images. The one or more images that are more similar to the one or more validation images can have higher confirmation scores than the one or more images that are less similar to the one or more validation images. Further, the one or more comparisons can be of images of the same region captured according to some image capture criteria (e.g., the latitude, longitude, and/or altitude of the images being compared are within a threshold range of similarity: the image data for compared images is within some threshold time range of similarity and/or date range of similarity: the angle of image capture and/or perspective of the images being compared is within a threshold angular range of similarity). In some embodiments, the one or more comparisons of the one or more images to the one or more validation images can include rotating the one or more images to match the pose more closely and/or alignment of the one or more validation images.

In some embodiments, the computing system can determine the one or more confirmation scores based at least in part on a determination of whether the one or more validation images match the one or more images. The determination of whether the one or more images match the one or more images can be based at least in part on the proportion of an images characteristics (e.g., resolution and/or feature geometry) that match. A greater proportion of matching can be associated with a higher confirmation score and a lower proportion of matching can be associated with a lower confirmation score.

In some embodiment, determining the one or more confirmation scores can include and/or be based at least in part on determination of an intersection over union for each of the one or more detections of the one or more images with respect to each of the one or more detections of the one or more validation images. The intersection over union can be based at least in part on the extent to which the one or more detections of the one or more images overlap the one or more detections of the one or more validation images. For example, the one or more detections (e.g., one or detections that are visually represented as vector based representations) of a high quality image (e.g., a recently captured high resolution nonoccluded image captured on a clear day) can be compared to the one or more detections of the same features in the one or more images that are of lower quality. The one or more confirmation scores can be positively correlated with the intersection over union (e.g., a higher confirmation score can be correlated with a relatively higher intersection over union).

In some embodiments, determining the one or more confirmation scores can include and/or be based at least in part on determination of an amount of overlap (e.g., a proportion of overlap) for each of the one or more detections of the one or more images with respect to each of the one or more detections of the one or more validation images. The amount of overlap can be based at least in part on the fractional amount that the one or more detections of the one or more images overlap the one or more detections of the one or more validation images. The one or more confirmation scores can be positively correlated with the amount of overlap (e.g., a higher confirmation score can be correlated with a relatively higher amount of overlap).

In some embodiment, determining the one or more confirmation scores can include and/or be based at least in part on the use of one or more greedy matching techniques. For example, use of the one or more greedy matching techniques can include traversing the one or more images and providing higher confirmation scores (e.g., confirmation scores above a predetermined confirmation score threshold) to the images that do not conflict (e.g., have an intersection over union that is below a threshold intersection over union) with those images that have an intersection over union that is above the threshold intersection over union.

The computing system can generate one or more indications based at least in part on the one or more confirmation scores for the one or more images. The one or more indications can be associated with an accuracy of the one or more detections of the one or more features in the one or more images. For example, the computing system can generate one or more indications that are displayed on a display device. The one or more indications can include some portion of the one or more confirmation scores and can indicate the accuracy of the vector based representation of an image that is presented. In some embodiments, the one or more indications can be triggered in response to one or more inputs (e.g., input from a user). For example, an image of a geographic area with a vector-based representation of roads and buildings can be displayed. The user can hover a pointer over a vector-based representation of a road to show an indication including a confirmation score for that portion of the image.

In some embodiments, the computing system can generate an interface (e.g., a user interface) that includes one or more indications associated with an accuracy of the one or more detections of the one or more features in the one or more images. The one or more indications can be based at least in part on the one or more confirmation scores for the one or more images. For example, the computing system can generate a user interface that includes a map of a geographic region (e.g., one or more images of the geographic region that were captured by aerial cameras). Further, the user interface can include one or more indications of the accuracy of the vector map that is superimposed on the map of the geographic region. For example, the one or more indications can indicate the accuracy of the vector-based representations of features in the map including roads and/or buildings.

The computing system can access, receive, obtain, and/or retrieve one or more inputs associated with at least one feature of the one or more features. The one or more inputs can be received via a user interface (e.g., a graphical user interface that is displayed on a display component and receives touch inputs from the user and/or an auditory user interface that uses one or more microphones to receive aural commands from the user). The one or more inputs from the user can be associated with selection of a feature of an image that is displayed on the user interface. For example, the user can select a vector based representation of a building feature that was detected by the computing system.

The computing system can generate an indication that can include and/or be associated with the confirmation score for the at least one feature. Further, the indication can be based at least in part on the one or more inputs. For example, in response to the computing system detecting one or more inputs of the user that indicate the user selected a portion of a building depicted in an image, the computing system can generate an indication indicating that the portion of the vector based representation of the building selected by the user is eighty percent (80%) likely to be accurate (e.g., the vector based representation overlaying the building feature has an intersection over union of that is close to one (1.0) with respect to the building feature).

In some embodiments, the one or more indications can be displayed on an interface (e.g., a user interface). The user interface can be associated with an application that displays a portion of the one or more images. Further, the application can include a map application and/or a navigation application. For example, the computing system can display the one or more indications on a user interface (e.g., a graphical user interface) that includes any of the one or more images with the one or more indications (e.g., a numeric confirmation score) generated as an overlay on top of the respective detected feature associated with confirmation score.

The computing system can determine and/or generate one or more quality scores. The one or more image quality scores can be associated with the one or more images and based at least in part on an extent to which each of the one or more images satisfies the one or more image quality criteria. For example, the computing system can determine the one or more image quality scores based at least in part on the image resolution, image age, and/or haze (e.g., cloud cover) detected in an image. Images with higher resolution, that are more recent, and/or have less haze will receive higher image quality scores than images with lower resolution, that are less recent, and that have more haze. In some embodiments, the one or more image quality criteria can be weighted. For example, the age or recentness criteria can be weighted more heavily than the haze criteria. Further, in some embodiments, the one or more image criteria can include criteria that must be satisfied in order to generate an image quality score. For example, the one or more image criteria can include a haze criteria in which an image with greater than twenty-five percent (25%) cloud cover does not receive an image quality score or receives an image quality score of zero (0) on a scale of zero (0) to one-hundred (100) in which one hundred is the highest score and indicative of the highest image quality.

Further, haze can include and/or be associated with anything that reduces and/or degrades the visual quality of any of the one or more images. Further, haze can include any type of noise that obscures or otherwise distorts one or more portions of an image. For example, haze can include clouds, pollution, dust, and/or other particles suspended in an the air that reduce the transparency of the air and thereby obscure one or more features in an image.

The computing system can select from the one or more images, the one or more validation images based at least in part on the one or more image quality scores that exceed an image quality threshold. For example, the computing system can select the one or more validation images from the images that have or are associated with the image quality score that is the highest for the portion of the region that is depicted in the image. By way of further example, the computing system can select the one or more validation images that satisfy some portion of the one or more image quality criteria. For example, the computing system can select the one or more validation images based on the images that have satisfied some portion (e.g., all or ninety percent (90%)) of the one or more image quality criteria.

In some embodiments, the image data can include information associated with an age or recentness of the one or more images and/or a date and/or time at which each of the one or more images was captured. The one or more confirmation scores can be negatively correlated with the age or recentness of any of the one or more images, the time of capture of any of the one or more images, and/or the date of capture of any of the one or more images. For example, the age of an image can be a factor that is used to determine the confirmation score for the image and an image that is older will have a lower confirmation score than an image that was more recently captured.

In some embodiments, the one or more image quality criteria can be associated with an extent to which the one or more features of the one or more images are similar to the one or more features of the one or more validation images. For example, the one or more image quality criteria can include criteria associated with the geometry of the one or more features of the one or more images to the one or more validation images and ca be used to determine the extent to which the geometry is similar (e.g., the features are in similar locations and oriented similarly).

In some embodiments, the image data can include information associated with the resolution of the one or more images, occlusions in the one or more images, and/or haze in the one or more images. For example, the image data can include information associated with the dimensions and the number of pixels in an image. Further, the image data can include information associated with what portion (e.g., what percentage) of an image is occluded or blocked by image artifacts and/or objects that are present in the image that block some significant feature (e.g., trees that occlude a portion of a road when viewed from a bird's eye perspective). Further, the image data can include information associated with an amount of haze (e.g., cloud cover, pollution, and/or smoke) that obscures one or more portions of the image.

In some embodiments, the one or more image quality criteria can be associated with a resolution of each of the one or more images (e.g., one or more resolutions of the one or more images respectively), an amount of occlusions in each of the one or more images, and/or an amount of haze in each of the one or more images. By way of further example, the one or more image quality criteria can include an occlusion criterion in which the number of occlusions in an image or the portion of an image that is occluded must be below a respective number (e.g., no more than three (3) occlusions) or portion (e.g., no greater than twenty percent (20%) of the image is occluded) to satisfy the criterion. Additionally, the one or more image quality criteria can include a haze criterion in which the amount of haze in an image must be below a respective amount (e.g., no greater than twenty percent (20%) of the image is obscured by haze) to satisfy the criterion

In some embodiments, the one or more image quality criteria can include one or more recentness criteria associated with a time at which an image was captured and/or an age of an image. For example, an image that is older than some recentness threshold (e.g., a date one year from the current date) may not satisfy a recentness criterion that requires an image to be no more than one year old.

In some embodiments, satisfying the one or more image quality can include the resolution of an image exceeding a threshold resolution. For example, the one or more image quality criteria can include an image resolution criterion in which the resolution of an image must be above a certain resolution (e.g., number of pixels) to satisfy the criterion.

In some embodiments, one or more images of the one or more images with a confirmation score below a confirmation score threshold can be discarded. For example, the computing system can generate a score from one (1) to one hundred (100) for each of the one or more images and determine that any of the one or more images with a confirmation score below eighty (80) will be discarded (e.g., not provided for display to a user).

In some embodiments, the one or more detections can be based at least in part on output from one or more machine-learned models configured to detect the one or more features of the one or more images. The one or more machine-learned models can be configured and/or trained to perform one or more operations including segmentation and/or extraction of features from one or more images. For example, the one or more machine-learned models can be configured and/or trained to generate an output including a vector map for various classes of features (e.g., roads, buildings, and/or municipal boundaries) based at least in part on input associated with one or more input images (e.g., the one or more images).

In some embodiments, the one or more machine-learned models can be trained based at least in part on and/or using training data that includes a sampling of images of geographic regions that are weighted based at least in part on a frequency with which one or more visual features of the geographic regions occur. For example, the one or more machine-learned models that are trained to extract one or more features from geographic regions that are primarily urban can be trained using samples of images that include a larger proportion of images that depict roads, buildings, and other urban features. By way of further example, the one or more machine-learned models that are trained to extract one or more features from geographic regions that are primarily rural can be trained using samples of images that include a larger proportion of images that depict forests, pasture land, and other rural features.

In some embodiments, the image data can include information associated with one or more classes associated with the one or more features in the one or more images. For example, the image data can include information associated with the classes of features that are present in an image and/or the location of objects within the image that are associated with particular classes of features. For example, the image data can include the location of one or more detections of roads within an image. Furthermore, the extent to which the one or more detections of the one or more images are similar to the one or more detections of the one or more validation images can be based at least in part on whether the one or more detections in the one or more images were detected by the one or more machine-learned models that generated the one or more detections of the one or more validation images. For example, the extent to which the one or more detections of the one or more images are similar to the one or more detections of the one or more validation images can be based at least in part on whether the one or more detections of an image were made by one or more machine-learned models trained using images that include the same feature classes that were used to train the one or more machine-learned models associated with the one or more validation images.

In some embodiments, the image data can include information associated with one or more geographic regions in which the one or more images were captured. Further, satisfying the one or more image quality criteria can include the one or more validation images satisfying one or more region criteria. The one or more region criteria can be associated with whether the one or more detections were made by one or more machine-learned models trained using images of the one or more geographic regions. For example, the one or more images for which the one or more detections were made by one or more machine-learned models trained using images of the one or more geographic regions can be weighted more heavily and can be more likely to be selected as the one or more validation images than the one or more images for which the one or more detections were made using one or more machine-learned models that are not trained using images of the one or more geographic regions.

In some embodiments, the one or more classes of the one or more features can include a building, a road, a railway track, airport, international boundary, national boundary, property boundary (e.g., the property lines between personal real estate property and/or business real estate property), a coastline, topographic contours, and/or a bridge. Further, the one or more classes of the one or more features can include any combination of the one or more classes of the one or more features (e.g., a combination including only roads, only buildings, or roads and buildings).

In some embodiments, the one or more detections can be associated with one or more vector maps that include one or more vector based representations of the one or more features. For example, the one or more detections can be based at least in part on one or more image segmentation techniques that were used to detect and/or recognize one or more features of an image. Further, the one or more detections can be visually represented as one or more vector based representations that are superimposed over the feature that was detected.

In some embodiments, the one or more images can include one or more images of geographic regions. For example, the one or more images can include images of different geographic regions and/or the same geographic region. The one or more images may have been captured over time (e.g., over a period of days, weeks, months, or years) and can have information associated with the latitude, longitude, and/or altitude of the region that was captured, the time of image capture, the date of image capture, one or more locations of landmarks in a region (e.g., the latitude, longitude, and/or altitude of a landmark), and/or the name of the region represented in the image.

In some embodiments, the image data can be based at least in part on information associated with an environment (e.g., an environment including the region associated with the image data) captured by one or more sensors of a satellite and/or one or more aerial sensors. Further, the one or more sensors can include one or more cameras, one or more LiDAR devices, and/or any other type of image capture device. For example, the input image can be based at least in part on satellite imagery.

The disclosed technology can include a computing system (e.g., a verification computing system) that is configured to perform various operations associated with verifying vector maps in images. In some embodiments, the verification computing system can be associated with various computing systems and/or devices that use, send, receive, and/or generate confirmation scores based on input that can include images of geographic regions. The verification computing system can include specialized hardware and/or software that enables the performance of one or more operations specific to the disclosed technology.

Furthermore, the verification computing system can include one or more application specific integrated circuits that are configured to perform operations associated with verifying vector maps. By way of example, the verification computing system can be configured to access images of geographic regions and verify the vector maps that were generated based on detection of features in the images.

The systems, methods, devices, apparatuses, and tangible non-transitory computer-readable media in the disclosed technology can provide a variety of technical effects and benefits including an improvement in the effectiveness of vector map verification. Further, improved map verification can assist a user in using a map. For example, the disclosed technology can assist the user in performing the technical task of navigating to a destination, by increasing the accuracy and/or reliability of the map data presented to the user. The disclosed technology can also provide a way to determine the accuracy and overall quality of the output of an image processing pipeline by generating validation scores that can be used to confirm the validity of vector maps. Further, computational resources and network usage can be more effectively used by identifying valid vector maps thereby reducing the occurrence of inaccurate vector maps and the expenditure of computational resources that are needed to continuously verify images.

Additionally, the techniques employed in the disclosed technology can reduce the number of times that images of a geographic area need to be recaptured due to a lack of confirmation that the vector map of the region is accurate. Especially in situations in which the expense (e.g., computational expense, network usage expense, and/or energy expense) associated with capturing an image is significant, the ability to confirm the validity and/or veracity of an image and/or the associated vector-based representations can reduce the number of times an image of the same area has to be recaptured, which can result in a reduction in network usage (and an associated reduction in the amount of data transferred) thereby increasing the amount of network resources available for other tasks.

As such, the disclosed technology can allow the user of a computing system to perform the technical task of verifying vector maps more effectively. As a result, users can be provided with the specific benefits of greater performance and more efficient use of system resources. Further, any of the specific benefits provided to users can be used to improve the effectiveness of a wide variety of devices and services including devices that use vector based representations of images. Accordingly, the improvements offered by the disclosed technology can result in tangible benefits to a variety of devices and/or systems including mechanical, electronic, and computing systems associated with vector map verification.

With reference now to the Figures, example embodiments of the present disclosure will be discussed in further detail.

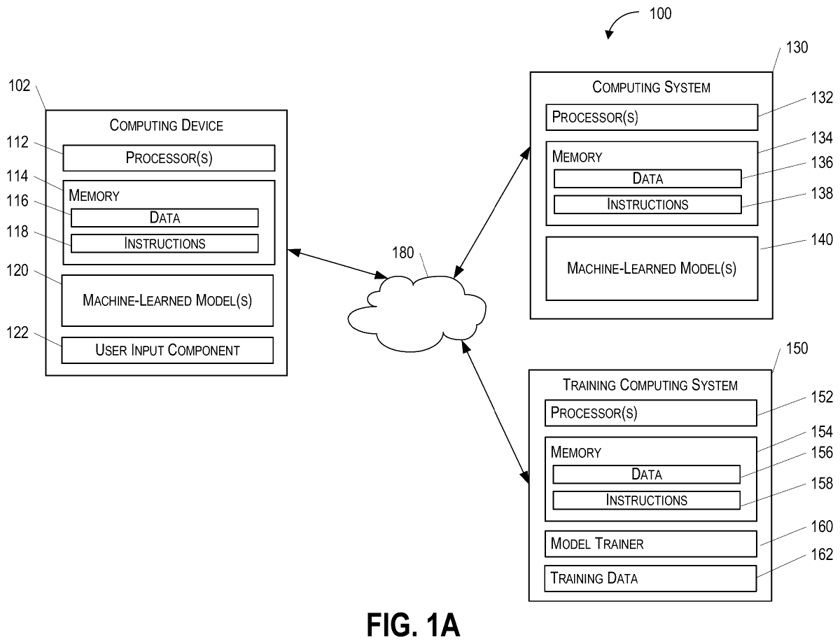

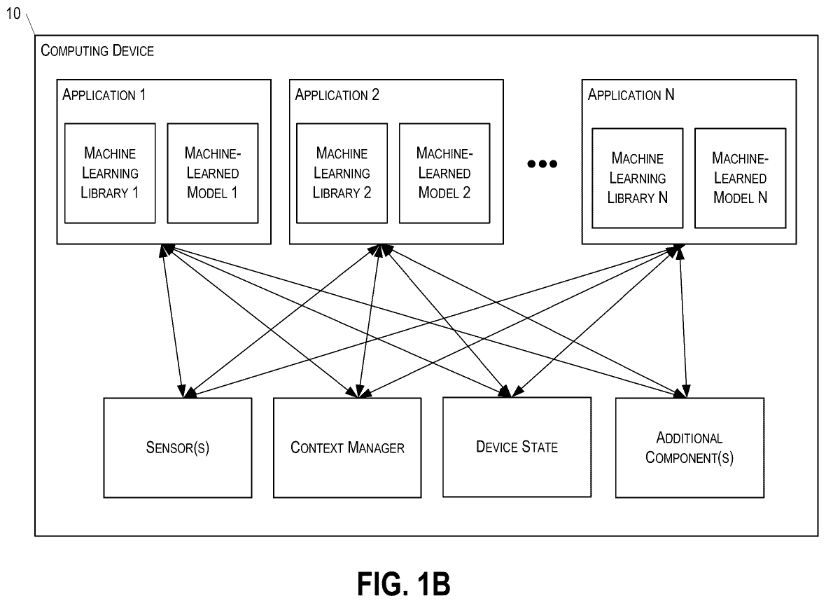

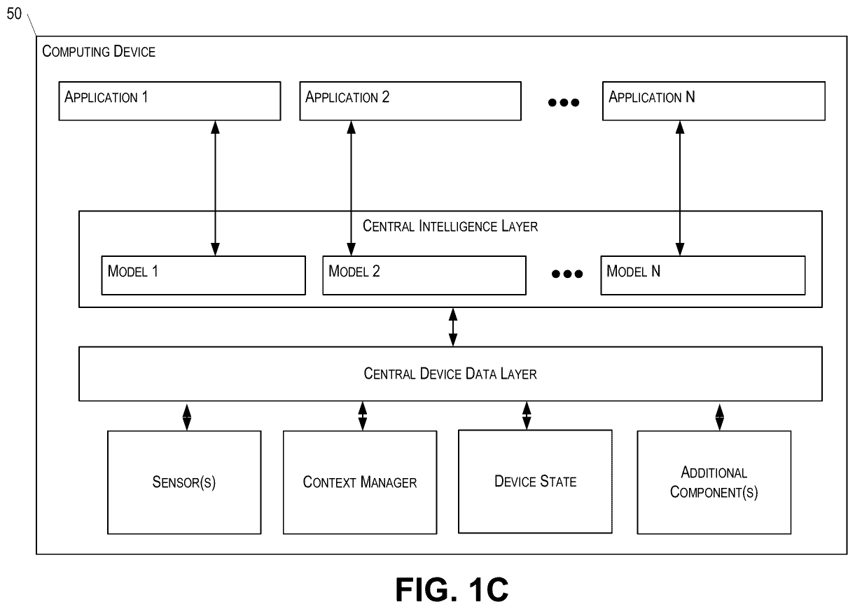

FIG. 1A depicts a block diagram of an example of a computing system that performs operations associated with vector map verification according to example embodiments of the present disclosure. The system 100 includes a computing device 102, a computing system 130, and a training computing system 150 that are communicatively coupled over a network 180.

The computing device 102 can include or be any type of computing device, including, for example, a personal computing device (e.g., laptop computing device or a desktop computing device), a mobile computing device (e.g., smartphone, or tablet), a gaming console or controller, a wearable computing device (e.g., a smart watch, a smart ring, smart glasses which can include one or more augmented reality features and/or virtual reality features), and/or an embedded computing device.

The computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more computer-readable mediums (e.g., tangible non-transitory computer-readable media), such as RAM, ROM, EEPROM, EPROM, flash memory devices, magnetic disks, etc., and combinations thereof. The memory 114 can store the data 116 and instructions 118 that are executed by the processor 112 to cause the computing device 102 to perform operations.

In some implementations, the computing device 102 can store or include one or more machine-learned models 120. For example, the one or more machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Examples of one or more machine-learned models 120 are discussed with reference to FIGS. 1A-8.

In some implementations, the one or more machine-learned models 120 can be received from the computing system 130 over network 180, stored in the memory 114, and then used or otherwise implemented by the one or more processors 112. In some implementations, the computing device 102 can implement multiple parallel instances of a single machine-learned model of the one or more machine-learned models 120 (e.g., to perform parallel operations to determine confirmation scores that indicate the accuracy of vector maps of images).

More particularly, the one or more machine-learned models 120 can be configured and/or trained to access data including image data that includes one or more images, select validation images from the one or more images, determine confirmation scores for the one or more images, and generate indications associated with the confirmation scores.

Additionally, or alternatively, one or more machine-learned models 140 can be included in or otherwise stored and implemented by the computing system 130 that communicates with the computing device 102 according to a client-server relationship. For example, the one or more machine-learned models 140 can be implemented by the computing system 130 as a portion of a web service (e.g., a vector map verification service that generates confirmation scores based on image data). Thus, one or more machine-learned models 120 can be stored and implemented at the computing device 102 and/or one or more machine-learned models 140 can be stored and implemented at the computing system 130.

The computing device 102 can also include one or more of the user input component 122 that is configured to receive user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more computer-readable mediums (e.g., tangible non-transitory computer-readable media), such as RAM, ROM, EEPROM, EPROM, flash memory devices, magnetic disks, etc., and combinations thereof. The memory 134 can store the data 136 and instructions 138 which are executed by the processor 132 to cause the computing system 130 to perform operations.

In some implementations, the computing system 130 includes or is otherwise implemented by one or more server computing devices. In instances in which the computing system 130 includes plural server computing devices, such server computing devices can operate according to sequential computing architectures, parallel computing architectures, or some combination thereof.

As described above, the computing system 130 can store or otherwise include one or more machine-learned models 140. For example, the one or more machine-learned models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Examples of the one or more machine-learned models 140 are discussed with reference to FIGS. 1A-8.

The computing device 102 and/or the computing system 130 can train the one or more machine-learned models 120 and/or the one or more machine-learned models 140 via interaction with the training computing system 150 that is communicatively coupled over the network 180. The training computing system 150 can be separate from the computing system 130 or can be a portion of the computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more computer-readable mediums (e.g., tangible non-transitory computer-readable media), such as RAM, ROM, EEPROM, EPROM, flash memory devices, magnetic disks, etc., and combinations thereof. The memory 154 can store the data 156 and instructions 158 which are executed by the processor 152 to cause the training computing system 150 to perform operations. In some implementations, the training computing system 150 includes or is otherwise implemented by one or more server computing devices.

The training computing system 150) can include a model trainer 160 that trains the machine-learned models 120 and/or 140 stored at the computing device 102 and/or the computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the one or more machine-learned models 120 and/or the one or more machine-learned models 140 based on a set of training data 162. The training data 162 can include, for example, one or more images including images of geographic regions (e.g., satellite and/or aerial images used in mapping applications and/or navigation applications). The training data 162 can be tagged with a feature classes included in each image. Further, the training data 162 can include information associated with the time the image were captured.

In some implementations, if the user has provided consent, the training examples can be provided by the computing device 102. Thus, in such implementations, the one or more machine-learned models 120 provided to the computing device 102 can be trained by the training computing system 150 on user-specific data received from the computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can include image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. For example, the text and/or natural language data can include one or more messages and/or one or more portions of audio (e.g., a spoken message) The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic objective output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can include speech data and/or image data that can include one or more portions of content (e.g., one or more portions of recorded audio). The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is of higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output. In some embodiments, the statistical data can include one or more statistics that are based at least in part on one or more features detected in images included in image data. For example, the statistical data can include the feature classes that are present in images, color statistics, and/or obfuscation statistics indicating the portion of an image that is obfuscated either by objects captured in the image or as a result of image artifacts that are the result of computational errors.

In some implementations, the input to the machine-learned model(s) of the present disclosure can include sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input can include visual data and the task can be a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A depicts a block diagram of an example computing system that performs operations associated with vector map verification according to example embodiments of the present disclosure. Other computing systems can be used as well. For example, in some implementations, the computing device 102 can include the model trainer 160 and the training data 162. In such implementations, the one or more machine-learned models 120 can be both trained and used locally at the computing device 102. In some of such implementations, the computing device 102 can implement the model trainer 160 to personalize the one or more machine-learned models 120 based on user-specific data.

FIG. 1B depicts a block diagram of an example of a computing device that performs operations associated with vector map verification according to example embodiments of the present disclosure. The computing device 10 can include a user computing device or a server computing device. Further, one or more portions of the computing device 10 can be included as part of the system 100 that is depicted in FIG. 1A.

The computing device 10 includes a number of applications (e.g., applications 1 through N). Each application contains its own machine learning library and machine-learned model(s). For example, each application can include a machine-learned model. Example applications include a mapping application, a navigation application, an image management application, a voicemail application, an email application, a dictation application, a virtual key board application, and/or a browser application.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device that performs operations associated with verification of vector maps according to example embodiments of the present disclosure. The computing device 50 can include a user computing device or a server computing device. Further, one or more portions of the computing device 50 can be included as part of the system 100 that is depicted in FIG. 1A.

The computing device 50 includes a number of applications (e.g., applications 1 through N). Each application is in communication with a central intelligence layer. Example applications include a mapping application, a navigation application, an image management application, a voicemail application, an email application, a dictation application, a virtual keyboard application, and/or a browser application. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

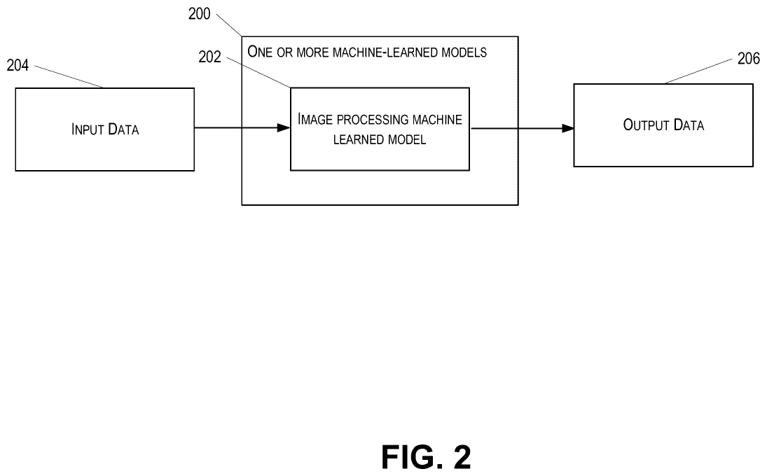

FIG. 2 depicts a block diagram of an example of one or more machine-learned models 200 according to example embodiments of the present disclosure. In some implementations, the one or more machine-learned models 200 are trained to receive a set of input data 204 that can include image data: and, after performing one or more operations on the input data 204, generating output data 206 that can include information associated with one or more confirmation scores associated with the validity and/or accuracy of vector maps and/or vector based representations of the image data. Thus, in some implementations, the one or more machine-learned models 200 can include an image processing machine-learned model 202 that is operable to generate output of indications including confirmation scores that are used to assist a user engaged in a vector based representation confirmation task.

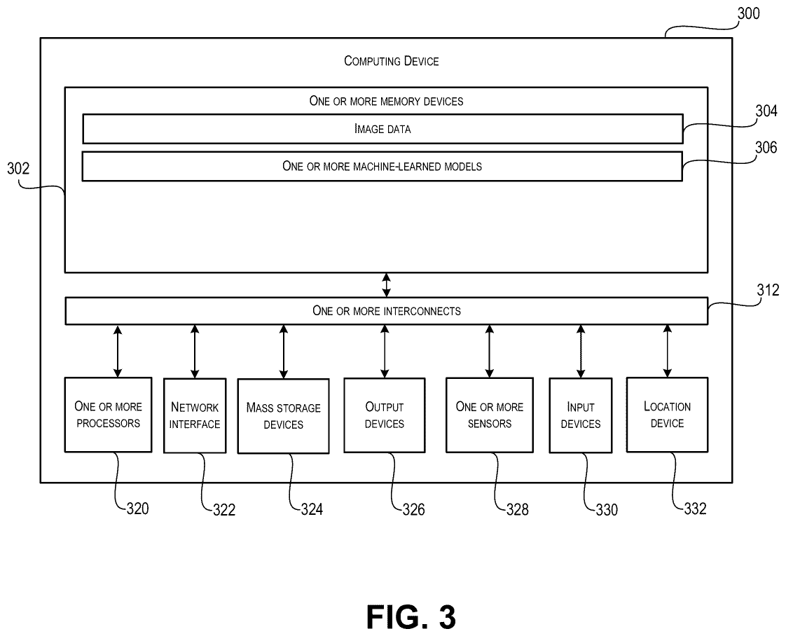

FIG. 3 depicts a diagram of an example computing device according to example embodiments of the present disclosure. A computing device 300 can include one or more attributes and/or capabilities of the computing device 102, the computing system 130, and/or the training computing system 150. Furthermore, the computing device 300 can perform one or more actions and/or operations including the one or more actions and/or operations performed by the computing device 102, the computing system 130, and/or the training computing system 150, which are depicted in FIG. 1A.

As shown in FIG. 3, the computing device 300 can include one or more memory devices 302, image data 304, one or more machine-learned models 306, one or more interconnects 312, one or more processors 320, a network interface 322, one or more mass storage devices 324, one or more output devices 326, one or more sensors 328, one or more input devices 330, and/or a location device 332.

The one or more memory devices 302 can store information and/or data (e.g., the image data 304 and/or the one or more machine-learned models 306). Further, the one or more memory devices 302 can include one or more computer-readable mediums (e.g., tangible non-transitory computer-readable media), including RAM, ROM, EEPROM, EPROM, flash memory devices, magnetic disks, and combinations thereof. The information and/or data stored by the one or more memory devices 302 can be executed by the one or more processors 320 to cause the computing device 300 to perform operations including operations associated with using the image data 304 to generate output including indications associated with confirmation scores indicating the validity and/or accuracy of image data.

The image data 304 can include one or more portions of image data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the image data 304 can include information associated with one or more images (and related metadata) that can be stored and/or implemented on the computing device 300. In some embodiments, the image data 304 can be received from one or more computing systems (e.g., the computing system 130 that is depicted in FIG. 1) which can include one or more computing systems that are remote (e.g., in another room, building, part of town, city, or nation) from the computing device 300.

The one or more machine-learned models 306 (e.g., the one or more machine-learned models 120 and/or the one or more machine-learned models 140) can include one or more portions of the data 116, the data 136, and/or the data 156 which are depicted in FIG. 1A and/or instructions (e.g., the instructions 118, the instructions 138, and/or the instructions 158 which are depicted in FIG. 1A) that are stored in the memory 114, the memory 134, and/or the memory 154, respectively. Furthermore, the one or more machine-learned models 306 can include information and/or instructions associated with accessing data including image data that includes one or more images, selecting validation images from the one or more images, determining confirmation scores for the one or more images, and generating indications associated with the confirmation scores. In some embodiments, the one or more machine-learned models 306 can be received from one or more computing systems (e.g., the computing system 130 that is depicted in FIG. 1) which can include one or more computing systems that are remote from the computing device 300.

The one or more interconnects 312 can include one or more interconnects or buses that can be used to send and/or receive one or more signals (e.g., electronic signals) and/or data (e.g., the image data 304 and/or the one or more machine-learned models 306) between components of the computing device 300, including the one or more memory devices 302, the one or more processors 320, the network interface 322, the one or more mass storage devices 324, the one or more output devices 326, the one or more sensors 328 (e.g., a sensor array), and/or the one or more input devices 330. The one or more interconnects 312 can be arranged or configured in different ways including as parallel or serial connections. Further the one or more interconnects 312 can include one or more internal buses to connect the internal components of the computing device 300; and one or more external buses used to connect the internal components of the computing device 300 to one or more external devices. By way of example, the one or more interconnects 312 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 320 can include one or more computer processors that are configured to execute the one or more instructions stored in the one or more memory devices 302. For example, the one or more processors 320 can, for example, include one or more general purpose central processing units (CPUs), application specific integrated circuits (ASICs), and/or one or more graphics processing units (GPUs). Further, the one or more processors 320 can perform one or more actions and/or operations including one or more actions and/or operations associated with the image data 304 and/or the one or more machine-learned models 306. The one or more processors 320 can include single or multiple core devices including a microprocessor, microcontroller, integrated circuit, and/or a logic device.

The network interface 322 can support network communications. For example, the network interface 322 can support communication via networks including a local area network and/or a wide area network (e.g., the Internet). The one or more mass storage devices 324 (e.g., a hard disk drive and/or a solid state drive) can be used to store data including the image data 304 and/or the one or more machine-learned models 306. The one or more output devices 326 can include one or more display devices (e.g., LCD display, OLED display, Mini-LED display, micro LED display, plasma display, and/or CRT display), one or more light sources (e.g., LEDs), one or more loudspeakers, and/or one or more haptic output devices (e.g., one or more devices that are configured to generate vibratory output).

The one or more input devices 330 can include one or more keyboards, one or more touch sensitive devices (e.g., a touch screen display), one or more buttons (e.g., ON/OFF buttons and/or YES/NO buttons), one or more microphones, and/or one or more cameras.

The one or more memory devices 302 and the one or more mass storage devices 324 are illustrated separately, however, the one or more memory devices 302 and the one or more mass storage devices 324 can be regions within the same memory module. The computing device 300 can include one or more additional processors, memory devices, network interfaces, which may be provided separately or on the same chip or board. The one or more memory devices 302 and the one or more mass storage devices 324 can include one or more computer-readable media, including, but not limited to, non-transitory computer-readable media, RAM, ROM, hard drives, flash drives, and/or other memory devices.

The one or more memory devices 302 can store sets of instructions for applications including an operating system that can be associated with various software applications or data. For example, the one or more memory devices 302 can store sets of instructions for applications that can generate output including one or more suggested routes. The one or more memory devices 302 can be used to operate various applications including a mobile operating system developed specifically for mobile devices. As such, the one or more memory devices 302 can store instructions that allow the software applications to access data including image data that is accessed and used to generate indications associated with confirmation scores. In other embodiments, the one or more memory devices 302 can be used to operate or execute a general-purpose operating system that operates on both mobile and stationary devices, including for example, smartphones, laptop computing devices, tablet computing devices, and/or desktop computers.

The software applications that can be operated or executed by the computing device 300 can include applications associated with the system 100 shown in FIG. 1A. Further, the software applications that can be operated and/or executed by the computing device 300 can include native applications and/or web-based applications.

The location device 332 can include one or more devices or circuitry for determining the position of the computing device 300. For example, the location device 332 can determine an actual and/or relative position of the computing device 300 by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or Wi-Fi hotspots, beacons, and the like and/or other suitable techniques for determining position.

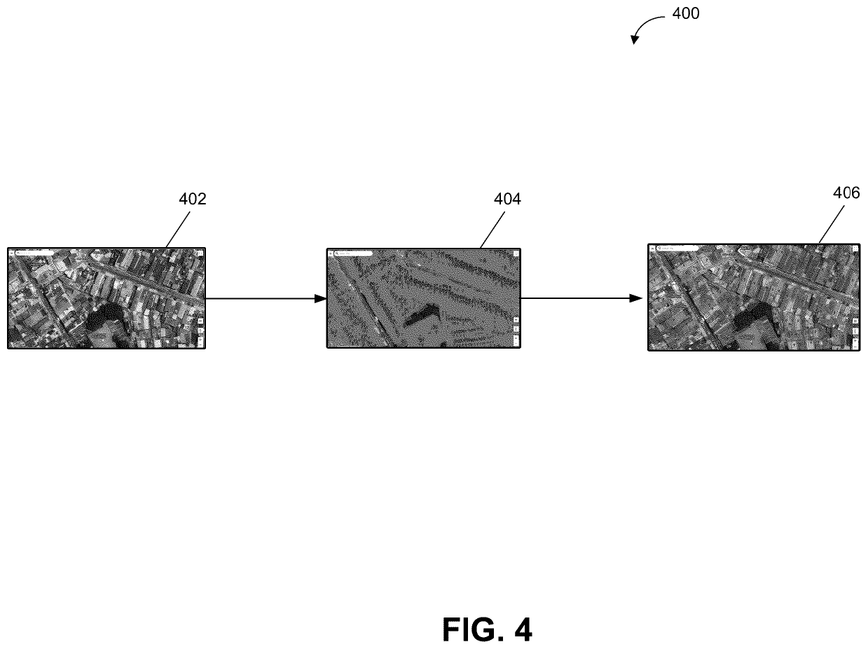

FIG. 4 depicts an example of vector map verification according to example embodiments of the present disclosure. Any operations and/or actions performed as part of the technique 400 can be performed by a computing device and/or computing system that includes one or more attributes and/or capabilities of the computing device 102, the computing system 130, and/or the training computing system 150. As shown in FIG. 4, the technique 400 generates an image 402, an image 404, and an image 406.

The image 402 can be based at least in part on image data that can be associated with one or more images. The image 402 can include a plurality of points (e.g., pixels) that can be analyzed by one or more machine-learned models to determine one or more features that are represented in the image 402. In some embodiments, the image 402 can be a single image that was captured at a single time. In some embodiments, the image 402 can include one or more images that may have been captured at different times and can have different image characteristics (e.g., image resolution).

A computing system and/or computing device can perform one or more operations on the image 402. For example, one or more machine-learned models can be used to detect one or more features of the image 402. Further, a computing system and/or computing device can segment the image 402 based at least in part on one or more classes of the one or more features (e.g., one or more feature classes). For example, the image 402 can be segmented based on one or more detections of one or more features associated with roads and/or buildings.

The image 404 represents output based at least in part on the image 402. For example, the image 404 can include one or more vector based representations of the features detected in the image 402. Further, the image 404 can include one or more indications associated with one or more confirmation scores that indicate the extent to which the one or more vector based representations of the image 404 accurately reflect the features of the image 402.

The image 406 represents output that is based at least in part on the image 402. The image 406 can include output that has been deduplicated (e.g., redundant vector-based representations associated with the image 402 and/or the image 404 have been discarded or not been made visible) based at least in part on the use of one or more confirmation scores. For example, the image 406 can include one or more vector based representations of the features detected in the image 402.

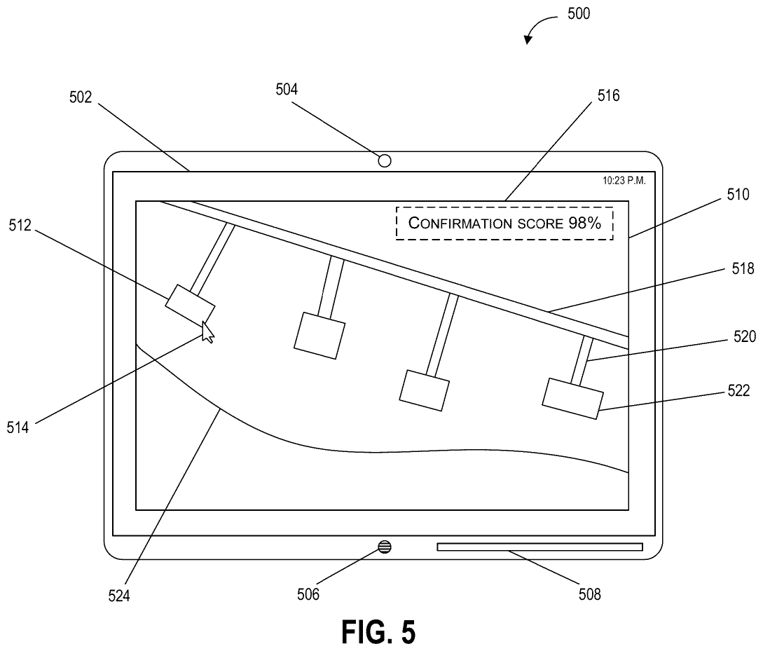

FIG. 5 depicts an example of a user interface implemented on a computing device according to example embodiments of the present disclosure. A computing device 500 can include one or more attributes and/or capabilities of the computing device 102, the computing system 130, the training computing system 150, and/or the computing device 300. Furthermore, the computing device 500 can perform one or more actions and/or operations including the one or more actions and/or operations performed by the computing device 102, the computing system 130, the training computing system 150, and/or the computing device 300.

As shown in FIG. 5, the computing device 500 includes a display component 502, an imaging component 504, an audio input component 506, an audio output component 508, a user interface 510, an interface element 512, an interface element 514, an interface element 516, an interface element 518, an interface element 522, and an interface element 524.

The computing device 500 can be configured to access image data (e.g., image data including one or more images of regions) and receive one or more inputs (e.g., touch inputs and/or inputs from an input device). Further, the display component 502 can be configured to receive inputs to the user interface 510. For example, the display component 502 can be configured to receive inputs including touch inputs and other tactile user interactions with the display component 502. Further, the display component 502 can be configured to receive inputs including touch inputs from one or more input devices (e.g., a mouse, keyboard, and/or a stylus).

Furthermore, the computing device 500 can be configured to generate one or more outputs. For example, the audio output component 508 can include one or more loudspeakers and can be configured to generate audible outputs including synthetic vocalizations associated with the interface element 516 (e.g., “CONFIRMATION SCORE 98%”).

The display component 502 can be configured to display a visual representation of the user interface 510 and any imagery that is generated within the user interface 510. Further, the user interface 510 can be associated with an application (e.g., a map application and/or navigation application that displays images in the user interface 510). For example, the user interface 510 can be used to display a navigation application and/or a mapping application that includes images of a geographic region.

In this example, the computing device 500 is implementing a map application that shows an image of a geographic region. In this example, the image of the geographic region is based on one or more images of the geographic region that were captured at different times and have been stitched together to form a cohesive image of the geographic region. The geographic region depicted in the user interface 510 is a bird's eye view of a coastal area in which the interface element 524 is a vector-based representation of the coastline separating dry land from the sea. The geographic region depicted in the user interface 510 includes an interface element 512 that is a vector-based representation associated with one or more detections of the features of a house by a machine-learned model. The interface element 514 is a pointer that is controlled by a user and is associated with the interface element 516 which displays a confirmation score. In this example, the user directs (e.g., via a pointer device) the interface element 514 over the interface element 512, which causes the interface element 516 to display “CONFIRMATION SCORE 98%” which indicates a high accuracy of the vector-based representation associated with the interface element 512. As such, the high confirmation score indicates that the vector-based representation of the features of a house are likely accurate.

Furthermore, the pointer associated with the interface element 514 can be used to determine the confirmation score associated with other interface elements. For example, the interface element 514 can be placed over the interface element 518 to generate a confirmation score that indicates whether the vector based representation of the road features associated with the interface element 518 are accurate. Further, the interface element 520 which is a vector based representation of a drive way can also be interacted with via the interface element 514 in order to determine a confirmation score for the interface element 520.

In some embodiments, a user can select a feature class (e.g., houses or roads) and the computing device 500 can provide a confirmation for the selected feature class and not other feature classes when the interface element 514 is placed above a vector based representation. For example, the interface element 512 and the interface element 522 are vector based representations of the same feature class (e.g., features of a house). The computing device 500 can be configured so that a confirmation score will only be displayed in the interface element 516 when the interface element 514 is placed over an interface element that has the selected feature class.

In some embodiments, the computing device 500 can receive one or more inputs (e.g., user inputs) via the imaging component 504 and/or the audio input component 506. For example, the imaging component 504 can include one or more cameras that are configured to receive input by capturing an image of an object (e.g., a user's hand) that is placed in the field of view of the imaging component 504. The computing device 500 can then perform one or more images recognition operations to detect the position of the object and perform one or more operations associated with the user interface 510 including selecting one or more interface elements. By way of further example, the audio input component 506 can include one or more microphones that are be configured to receive one or more sound inputs including auditory inputs. Further, the audio input component 506 can detect a user's voice and perform one or more operations including selecting an interface that a user identified with a vocal command.

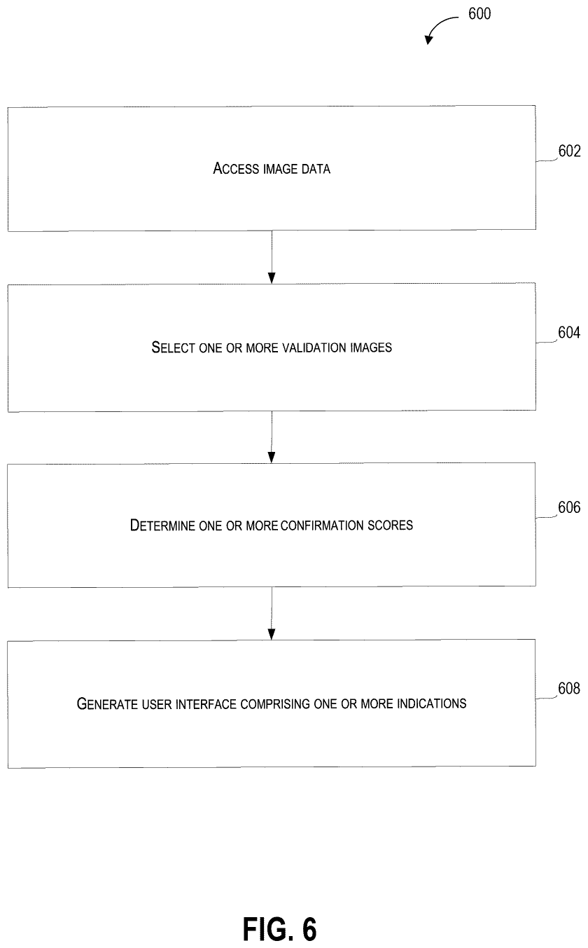

FIG. 6 depicts a flow diagram of vector map verification according to example embodiments of the present disclosure. One or more portions of the method 600 can be executed and/or implemented on one or more computing devices or computing systems including, for example, the computing device 102, the computing system 130, and/or the training computing system 150. Further, one or more portions of the method 600 can be executed or implemented as an algorithm on the hardware devices or systems disclosed herein. FIG. 6 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 602, the method 600 can include accessing image data that can include information associated with one or more images of a region. The one or more images can be associated with one or more detections of one or more features of the one or more images. For example, the computing system 130 can access image data that is locally and/or remotely stored and includes information associated with one or more images of a geographic region that were captured over a period of months (e.g., twelve (12) images of a geographic region captured every two (2) months for a period of twenty-four (24) months). The one or more images can include information associated with one or more vector based representations that are associated with features depicted in the one or more images.

At 604, the method 600 can include selecting one or more validation images from the one or more images. The one or more validation images can include the one or more images that satisfy one or more image quality criteria. For example, the computing system 130 can select one or more validation images that are of high quality based at least in part on one or more image quality criteria including resolution, haze, and/or occlusion. For example, the one or more validation images can include an image that has a higher resolution than other images in the one or more images and that does not have any visible haze (e.g., cloud cover) or occlusions (e.g., tree coverage that blocks an overhead view of a house).

At 606, the method 600 can include determining, for one or more classes associated with the one or more features and based at least in part on one or more comparisons of the one or more images to the one or more validation images, one or more confirmation scores for the one or more images. The one or more confirmation scores can be associated with an extent to which the one or more detections associated with the one or more images are similar to the one or more detections associated with the one or more validation images of the one or more images.

For example, the computing system 130 can compare each of the one or more images of a geographic region to a validation image of the same geographic region. The computing system 130 can then analyze the one or more detections (e.g., one or more detections of features that are represented as one or more portions of a vector map including roads) to determine the amount of similarity between the one or more images and the one or more validation images. For example, the amount of similarity can be based at least in part on an intersection over union between an image (e.g., a non-validation image) and a validation image. The computing system 130 can then generate a confirmation score that indicates the amount of similarity between an image and a corresponding validation image. For example, the confirmation score can be a numeric value from zero (0) to one-hundred (100) in which a higher numeric value is associated with a greater confirmation of the probability or likelihood that the vector-based representations in an image are accurate.

At 608, the method 600 can include generating one or more indications based at least in part on the one or more confirmation scores for the one or more images. The one or more indications can be associated with an accuracy of the one or more detections of the one or more features in the one or more images. For example, the computing system 130 can generate one or more indications including one or more confirmation scores (e.g., numeric values) that are displayed over the one or more detections that are shown as vector-based representations of roads in an image.

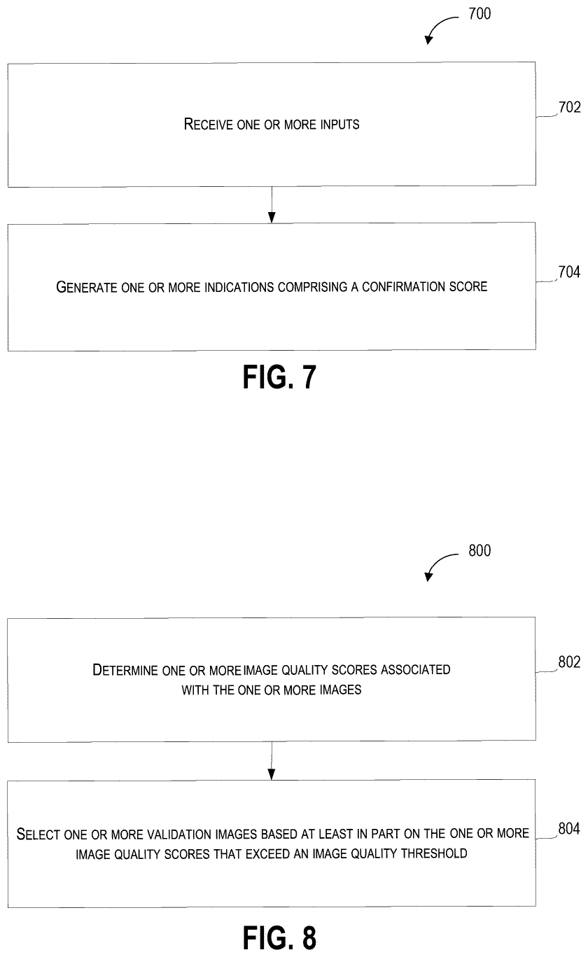

FIG. 7 depicts a flow diagram of vector map verification according to example embodiments of the present disclosure. One or more portions of the method 700 can be executed and/or implemented on one or more computing devices or computing systems including, for example, the computing device 102, the computing system 130, and/or the training computing system 150. Further, one or more portions of the method 700 can be executed or implemented as an algorithm on the hardware devices or systems disclosed herein. In some embodiments, one or more portions of the method 700 can be performed as part of the method 600 that is depicted in FIG. 6. FIG. 7 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 702, the method 700 can include receiving one or more inputs associated with at least one feature of the one or more features. The one or more inputs can be received via a user interface. The one or more inputs from the user can be associated with a feature of an image that is displayed on the user interface. For example, the computing device 102 can generate a user interface that shows images of a geographic region that includes vector based representations that indicate the presence of buildings, roads, and other objects depicted in the image of the geographic region. The one or more inputs can include the user selecting (e.g., via touch or an on-screen pointer) a feature (a portion of a vector based representation of a road) depicted in an image.

At 704, the method 700 can include generating, based at least in part on the one or more inputs, an indication comprising the confirmation score associated with the at least feature. For example, in response to the computing device 102 receiving one or more inputs indicating that the user selected a portion of road, the computing device 102 can generate an indication indicating that the portion of the vector based representation of the road that the user selected is ninety percent (90%) likely to accurately reflect the underlying features of the image.

FIG. 8 depicts a flow diagram of vector map verification according to example embodiments of the present disclosure. One or more portions of the method 800 can be executed and/or implemented on one or more computing devices or computing systems including, for example, the computing device 102, the computing system 130, and/or the training computing system 150. In some embodiments, one or more portions of the method 800 can be performed as part of the method 600 that is depicted in FIG. 6. Further, one or more portions of the method 800 can be executed or implemented as an algorithm on the hardware devices or systems disclosed herein. FIG. 8 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 802, the method 800 can include determining one or more image quality scores respectively associated with the one or more images and based at least in part on an extent to which each of the one or more images satisfies the one or more image quality criteria. For example, the computing system 130 can determine the one or more image quality scores based at least in part on the image resolution detected in an image. Images with higher resolution can receive a higher image quality score than images with lower resolution (e.g., a resolution below an image resolution threshold).

At 804, the method 800 can include selecting, from the one or more images, the one or more validation images based at least in part on the one or more image quality scores that exceed an image quality threshold. For example, the computing system 130 can select the one or more validation images that have the image quality score that is the highest for the portion of the region that is depicted in the image.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A computer-implemented method of vector map verification, the computer-implemented method comprising:
accessing, by a computing system comprising one or more processors, image data comprising information associated with one or more images of a region, wherein the one or more images are associated with one or more detections of one or more features of the one or more images;
selecting, by the computing system, one or more validation images from the one or more images, wherein the one or more validation images satisfy one or more image quality criteria;
determining, by the computing system, for one or more classes associated with the one or more features and based at least in part on one or more comparisons of the one or more images to the one or more validation images, one or more confirmation scores for the one or more images, wherein the one or more confirmation scores are associated with an extent to which the one or more detections associated with the one or more images are similar to the one or more detections associated with the one or more validation images from the one or more images; and
generating, by the computing system, a user interface comprising one or more indications associated with an accuracy of the one or more detections of the one or more features in the one or more images, wherein the one or more indications are based at least in part on the one or more confirmation scores for the one or more images.

2. The computer-implemented method of claim 1, further comprising:
receiving, by the computing system, one or more inputs associated with at least one feature of the one or more features; and
generating, by the computing system, based at least in part on the one or more inputs, an indication comprising the confirmation score associated with the at least one feature.

3. The computer-implemented method of claim 1, wherein the one or more indications are displayed on the user interface, wherein the user interface is associated with an application that displays a portion of the one or more images, and wherein the application comprises a map application or a navigation application.

4. The computer-implemented method of claim 1, further comprising:
determining, by the computing system, one or more image quality scores respectively associated with the one or more images and based at least in part on an extent to which each of the one or more images satisfies the one or more image quality criteria; and
selecting, by the computing system, from the one or more images, the one or more validation images based at least in part on the one or more image quality scores that exceed an image quality threshold.

5. The computer-implemented method of claim 1, wherein the image data comprises information associated with an age of the one or more images, and wherein the one or more confirmation scores are negatively correlated with one or more respective ages of the one or more images.

6. The computer-implemented method of claim 1, wherein the one or more image quality criteria are associated with an extent to which the one or more features of the one or more images are similar to the one or more features of the one or more validation images.

7. The computer-implemented method of claim 1, wherein the image data comprises information associated with a resolution of the one or more images, occlusions in the one or more images, or haze in the one or more images.

8. The computer-implemented method of claim 1, wherein the one or more image quality criteria are associated with a resolution of each of the one or more images, an amount of occlusions in each of the one or more images, or an amount of haze in each of the one or more images.

9. The computer-implemented method of claim 1, wherein the one or more image quality criteria comprise one or more recentness criteria associated with a time at which an image of the one or more images was captured.

10. The computer-implemented method of claim 1, wherein the satisfying the one or more image quality criteria comprises a resolution of an image exceeding a threshold resolution.

11. The computer-implemented method of claim 1, wherein one or more images of the one or more images with a confirmation score below a confirmation score threshold are discarded.

12. The computer-implemented method of claim 1, wherein the one or more detections are based at least in part on output from one or more machine-learned models configured to detect the one or more features of the one or more images.

13. The computer-implemented method of claim 12, wherein the extent to which the one or more detections associated with the one or more images are similar to the one or more detections of the one or more validation images is based at least in part on whether the one or more detections in the one or more images were detected by the one or more machine-learned models that generated the one or more detections of the one or more validation images.

14. The computer-implemented method of claim 12, wherein the image data comprises information associated with one or more geographic regions in which the one or more images were captured, and wherein the satisfying the one or more image quality criteria comprises the one or more validation images satisfying one or more region criteria associated with whether the one or more detections were made by one or more machine-learned models trained using images of the one or more geographic regions.

15. One or more tangible non-transitory computer-readable media storing computer-readable instructions that when executed by one or more processors cause the one or more processors to perform operations, the operations comprising:
accessing image data comprising information associated with one or more images of a region, wherein the one or more images are associated with one or more detections of one or more features of the one or more images;
selecting one or more validation images from the one or more images, wherein the one or more validation images comprise the one or more images that satisfy one or more image quality criteria;
determining, for one or more classes associated with the one or more features and based at least in part on one or more comparisons of the one or more images to the one or more validation images, one or more confirmation scores for the one or more images, wherein the one or more confirmation scores are associated with an extent to which the one or more detections associated with the one or more images are similar to the one or more detections associated with the one or more validation images from the one or more images; and
generating a user interface comprising one or more indications associated with an accuracy of the one or more detections of the one or more features in the one or more images, wherein the one or more indications are based at least in part on the one or more confirmation scores for the one or more images.

16. The one or more tangible non-transitory computer-readable media of claim 15, wherein the one or more classes comprise a building, a road, or a bridge.

17. The one or more tangible non-transitory computer-readable media of claim 15, wherein the one or more detections are associated with one or more vector maps comprising one or more vector based representations of the one or more features.

18. A computing system comprising:
one or more processors;
one or more non-transitory computer-readable media storing instructions that when executed by the one or more processors cause the one or more processors to perform operations comprising:
accessing image data comprising information associated with one or more images of a region, wherein the one or more images are associated with one or more detections of one or more features of the one or more images;
selecting one or more validation images from the one or more images, wherein the one or more validation images comprise the one or more images that satisfy one or more image quality criteria;
determining, for one or more classes associated with the one or more features and based at least in part on one or more comparisons of the one or more images to the one or more validation images, one or more confirmation scores for the one or more images, wherein the one or more confirmation scores are associated with an extent to which the one or more detections associated with the one or more images are similar to the one or more detections associated with the one or more validation images from the one or more images; and
generating a user interface comprising one or more indications associated with an accuracy of the one or more detections of the one or more features in the one or more images, wherein the one or more indications are based at least in part on the one or more confirmation scores for the one or more images.

19. The computing system of claim 18, wherein the one or more images comprise one or more images of one or more geographic regions.

20. The computing system of claim 18, wherein the image data is based at least in part on information associated with an environment comprising the region and captured by one or more sensors of a satellite or one or more aerial sensors, and wherein the one or more sensors comprise one or more cameras.
